(19) United States
(12) Patent Application Publication
(10) Pub. No.: US 2003/0145321 A1
(43) Pub. Date: Jul. 31, 2003

(54) System and method for managing access to TV channels and shows

(75) Inventors: Cary L. Bates, Rochester, MN (US); Gilford F. Martino, Endwell, NY (US); John M. Santosuosso, Rochester, MN (US); Vincent T. Timon III, Binghamton, NY (US)

Correspondence Address: IBM Corporation, Intellectual Property Law Dept 917, 3605 Highway 52 North, Rochester, MN, 55901-7829, US

(73) Assignee: International Business Machines Corporation, Armonk, NY (US)

(21) Appl. No.: 10/061,404

(22) Filed: Jan. 31, 2002

(51) Int. Cl. H04N 7/16; H04N 5/445

(52) U.S. Cl. 725/25; 725/46; 725/29; 725/28

(57) ABSTRACT

A system and method is provided for controlling selection of channels and shows for viewing. A program selection device, such as a set top box, is programmed to maintain a channel list and a show list, with the channel list containing for each of a plurality of channels the allowed and actual time of viewing and the show list containing for each show the allowed and actual time of viewing. The show list may also include a rating value for each show. The channel list and show list are accessed for selectively controlling whether or not a particular channel or show is to be presented for viewing by a user.

### BACKGROUND OF THE INVENTION

1. Technical Field of the Invention

This invention pertains to managing access to television channels and shows. More particularly, it provides a system and method for programming viewing controls on a television set top box.

2. Background Art

A set top box is a device that can convert analog and/or digital signals received from a cable company or a home satellite system into a format that can be viewed on a television set. Many of the set top boxes that have been developed within the past few years have an internal processor that can execute a programming language. The programming language which is executed by the processor can be used to control the functions of the set top box. The JAVA programming language is often used for this purpose.

Many children spend a great deal of time in front of the television set and are unmonitored leaving them to watch whatever they want for as long as they want. There is a need in the art, therefore, for allowing access restrictions and/or time limits to be defined for certain channels and/or programs. Further, to allow such controls to be defined for individual persons.

Television controls may include an electronic program guide (EPG), and these typically display a show schedule for many channels and programs. With the growth in the number of channels, the EPG can become very complex and confusing to view. There is a need in the art for simplifying the EPG to display only those channels and shows of interest or available to a particular viewer.

It is an object of the invention to provide an improved system and method for operating a channel selection device, such as a set top box.

It is a further object of the invention to provide a system and method for operating a channel selection device to control the channels and programs available for viewing.

It is a further object of the invention to provide a system and method for operating a channel selection device to control the amount of time an individual may view a particular channel or program in a given period.

It is a further object of the invention to provide a system and method for operating a channel selection device during channel surfing to skip blocked channels or shows.

It is a further object of the invention to provide a system and method for operating a channel selection device for reporting the channels and shows viewed by an individual, and the elapsed time of viewing.

It is a further object of the invention to provide a system and method for providing password protection to a channel selection device.

It is a further object of the invention to provide an electronic program guide (EPG) personalized for displaying selected channels and programs.

### SUMMARY OF THE INVENTION

A system and method is provided for controlling selection of channels and shows for viewing. A program selection device, such as a set top box, is programmed to maintain a channel list and a show list, with the channel list containing for each of a plurality of channels the allowed and actual time of viewing and the show list containing for each show the allowed and actual time of viewing. The show list may also include a rating value for each show. The channel list and show list are accessed for selectively controlling whether or not a particular channel or show is to be presented for viewing by a user.

In accordance with an aspect of the invention, there is provided a computer program product configured to be operable to control selection of channels and shows for viewing.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a high level schematic drawing of a television system showing program and surf controls compatible with the present invention.

FIG. 2 is a high level schematic drawing of a set box top adaptable for executing the preferred embodiments of the present invention.

FIG. 3 illustrates a channel list in accordance with a preferred embodiment of the invention.

FIG. 4 illustrates a show list in accordance with a preferred embodiment of the invention.

FIGS. 5A-5C are a flow chart illustrating a preferred embodiment of the invention for controlling channel and show viewing.

### BEST MODE FOR CARRYING OUT THE INVENTION

Most children spend a great deal of time in front of the television set and most are unmonitored leaving them to watch whatever they want for as long as they want. With the advent of Java TV and the ability to have programming logic sit in set top boxes we can now better control the usage of the television set by systematically programming what and how the device is to be used.

The invention extends the current channel locking capability to include not only full channel locks, and locks if a program has a certain rating, but locks which allow only so much access to a particular show or channel and which manage the shows presented while channel surfing.

In accordance with various exemplary embodiments of the invention:

1. The set top box is programmed to allow access to particular channels for a given amount of time. For example, a parent may not care about how much time a child watches a particular educational channel, but may desire to limit access to a particular entertainment channel to an hour a day.

2. The set top box is programmed to allow access at the show level for a given period of time. For example, a parent may desire to limit a child to one episode per day of a particular program.

3. The set top box is programmed to not allow children access to shows that have already been watched. Likewise for adults a channel surf feature is provided that selectively skips over those stations broadcasting a program which has already viewed.

4. The set top box is programmed to update the electronic program guide (EPG), to show which channels and which shows have been watched.

5. The set top box is programmed to allow a user to indicate which shows he/she would or wouldn't mind seeing again, such as a movie that was particularly poor or good.

In accordance with a further embodiment of the invention, the set top box provides an indication in the EPG that shows a user's rating (ie. John's Rating Value, or Users Rating Value (URV)) which rates the show after it is over and is maintained for each user. This allows the user to surf to and display all show's that are new or are rated equal to or over a specified URV. The EPG may be programmed to either mark or not display programs which have already been viewed or which are below a particular URV, or to highlight those which have not been viewed or are above a particular URV. When surfing through channels, channels which are currently showing programs which have already been viewed or are below a particular URV may be skipped, or alternatively those which have not been viewed and those which are above a particular URV displayed.

In accordance with a further embodiment of the invention, television viewing accounts and corresponding passwords are created for each or a group of persons. An account and its password may be entered either when the set top box is turned on, or from a dialog screen when a change in account is desired. A default account may be created to handle the situation where an account and its password are not entered. A given account may be authorized to view only certain channels and/or programs. In addition to restricting access to certain channels, certain programs, or programs above a particular rating level, time limits on the viewing of certain channels and/or programs may be implemented. Viewing time may also be charged to an account which would allow reports to be created showing the channels and programs viewed, as well as the time spent viewing them.

In accordance with a further embodiment of the invention, hours of viewing are tracked to particular accounts. For example open access (i.e. no pass code entered) can be viewed as one account such that when a show is watched, time is charged against this default account and when a threshold is exceeded the show or channel is blocked and thereafter a lock code will be required to access the channel. Alternatively a pass code may be entered to charge time against. This way, for example, each child may be given a certain amount of TV viewing time. This is done upon the TV being turned on by prompting the user for a user ID. When the user selects a channel, there is a password screen that requires an entry, so that time can be charged against the correct account. If the user does not have access to this channel, then the channel remains blank.

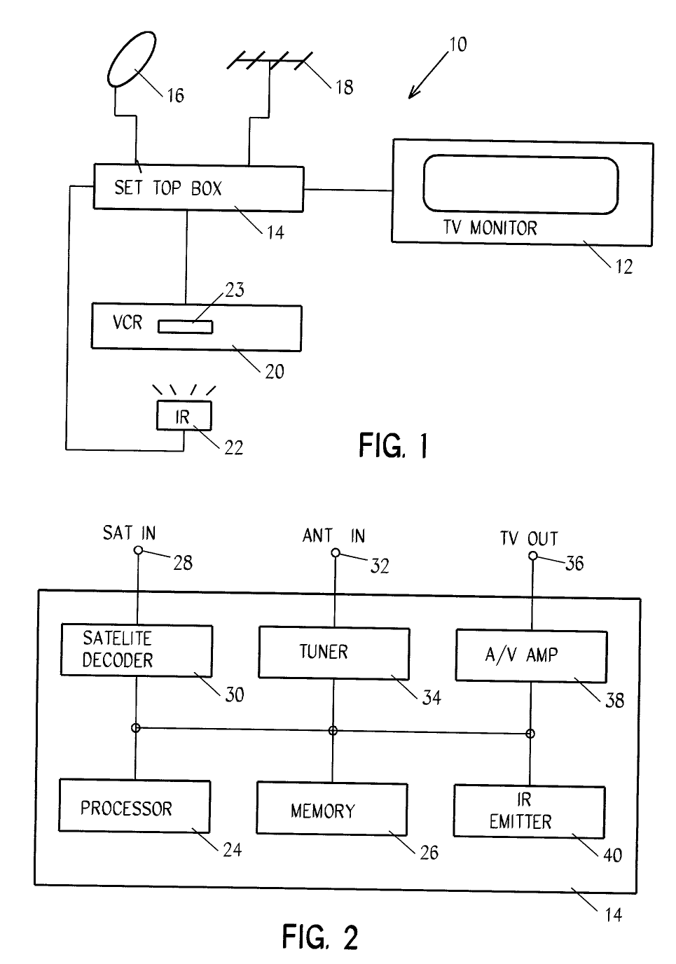

Turning to the Drawings, wherein like numbers denote like parts throughout the several views, FIG. 1 illustrates a television system 10 incorporating program view controls consistent with the invention. System 10 includes a television or monitor 12 coupled to a set top box 14 to receive audio and video signals therefrom. Set top box 14 in the illustrated implementation is a satellite receiver capable of receiving satellite television broadcast signals via a direct broadcast satellite (DBS) dish 16, as well as off-air television broadcast signals via an antenna 18 (or alternately, a cable provider).

Also illustrated in system 10 is a video cassette recorder (VCR) 20, coupled to receive input from set top box 14, as well as any additional sources, e.g., off-air or cable television broadcast signals (not shown separately). VCR 20 may also be capable of optionally outputting audio and video signals directly to television/monitor 12, rather than passing such signals through set top box 14.

Set top box 14 in the illustrated embodiment is capable of controlling VCR 20 to execute the view and surf controls of the present invention. Such controls may be provided via a serial communications interface, or via infrared (IR) or ultra high frequency (UHF) remote control signals (e.g., as illustrated by infrared emitter 22 positioned to direct infrared control signals to an infrared receiver 23 on VCR 20).

Program viewing and surfing controls of television programs is provided by a television viewing monitor apparatus, implemented in the illustrated implementation within set top box 14. However, it will be appreciated by those of ordinary skill in the art having benefit of the instant disclosure that such functionality may be implemented in any number of devices capable of monitoring the viewing of television programs in a television system, including, for example, televisions, personal video recorders (e.g., the ReplyTV recorders available from Replay Networks and the Tivo receivers from Philips Consumer Electronics), computers, VCR's, etc. Further, a television viewing monitor apparatus need not necessarily be capable of directly receiving and/or displaying television programs to viewers, so long as such an apparatus has the capability of detecting what programs are being accessed for viewing by a separate display. In addition, television programs to be viewed may be received from any number of sources, including off-air broadcast sources, cable television sources, satellite television sources, and computer network sources such as the Internet. Moreover, system 10 may utilize other storage technologies to record television programs, including, for example, recordable optical media (e.g., CD's, DVD's), magnetic or magneto optical media (e.g., hard or floppy disk drives), solid state memory, etc.

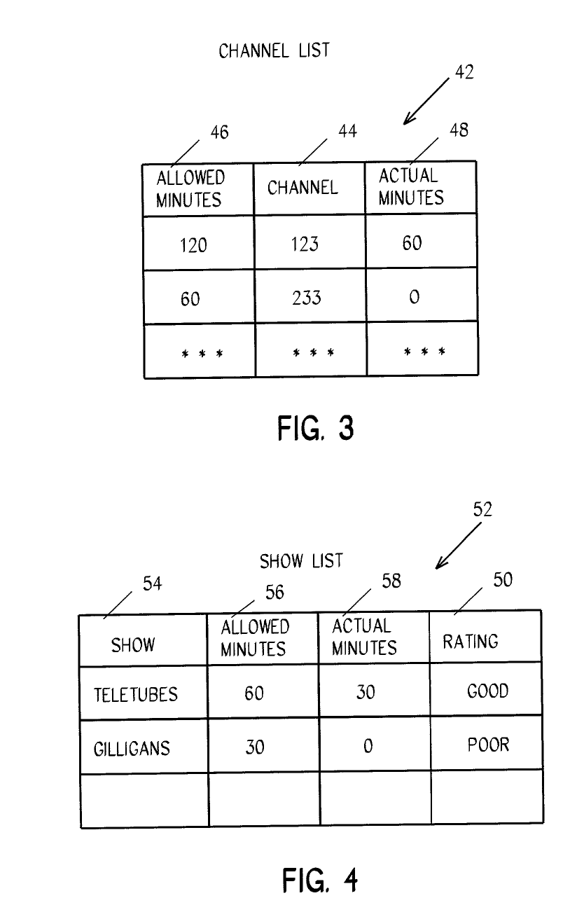

Now turning to FIG. 2, set top box 14 is illustrated in greater detail. Set top box 14 is under the control of a processor 24, which is interfaced with a memory 26 storing both program code suitable for execution by the processor, as well as additional data structures required by the processor in controlling the operation of the set top box. Processor 24 may represent one or more processors (e.g., microprocessors or micro-controllers), and memory 26 may represent random access memory (RAM) devices comprising the main storage of the set top box, as well as any supplemental levels of memory, e.g., cache memories, non-volatile or backup memories (e.g., programmable or flash memories), read-only memories, etc. In addition, memory 26 may be considered to include memory storage physically located elsewhere in set top box 14, e.g., any cache memory in processor 24, as well as any storage capacity used as a virtual memory, e.g., as stored on a mass storage device or on another data processing system coupled to set top box 14 via an external network (not shown).

Satellite television broadcast signals are received by set top box 14 through a satellite input 28 and decoded by a satellite signal decoder 30. Likewise, off-air or cable television signals are received through an antenna input 32 and processed by a tuner 34. Audio and/or video data output by either of decoder 30 and tuner 34 are output to a television or video monitor through a TV output 36 driven by audio/video amplification circuitry 38. Furthermore, control of an external storage device such as a VCR is provided via an infrared emitter driver 40, to which an infrared emitter may provide user input via front panel buttons, etc.

Set top box 14 operates under the control of an embedded operating system, and executes or otherwise relies upon various software and/or firmware applications, components, programs, objects, modules, data structures, etc. In general, the routines executed to implement the embodiments of the invention, whether implemented as part of an operating system or a specific application, component, program, object, module or sequence of instructions, will be referred to herein as “computer programs”, or simply “programs”. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and other programmable electronic devices, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environment, including implementations partly or wholly in hardwired logic, may be used without departing from the scope of the invention.

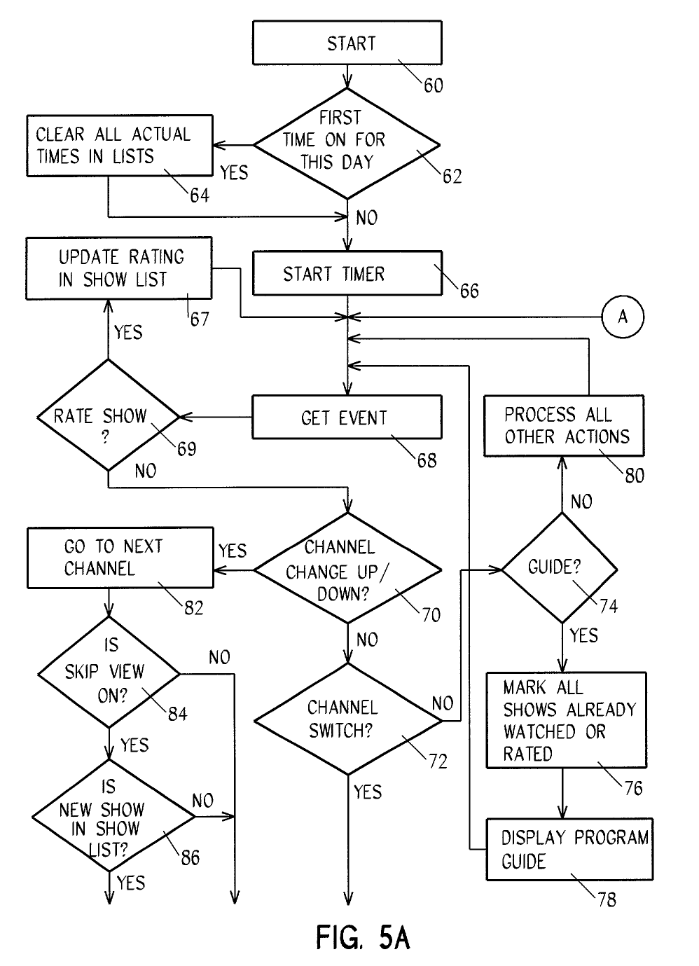

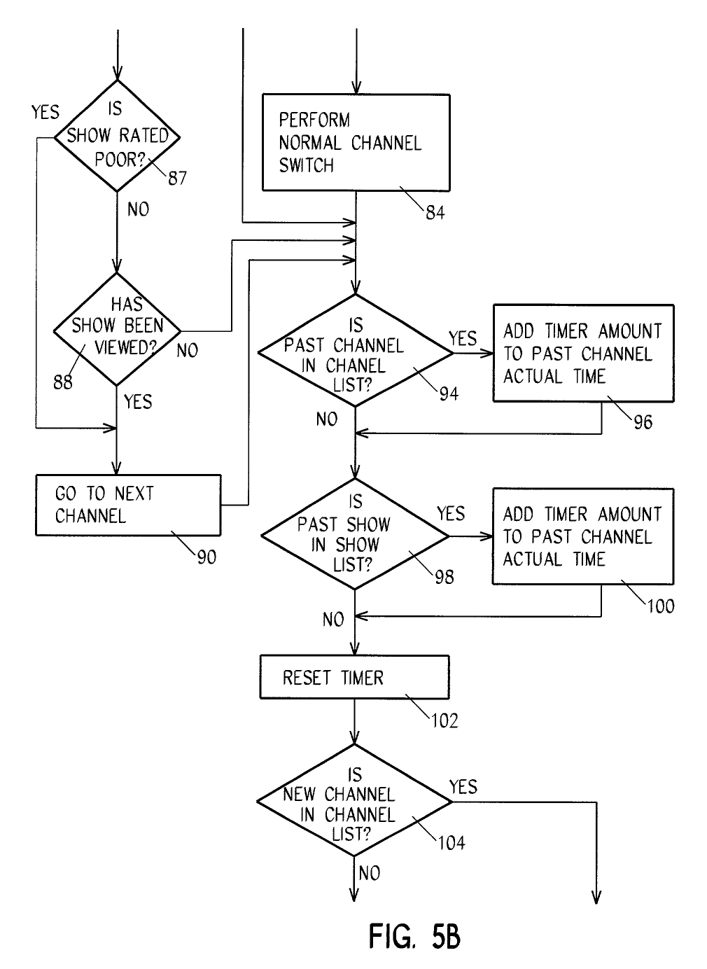

Referring to FIGS. 3 and 4, exemplary list or table structures used in preferred embodiments of the invention are illustrated. Channel list 42 records for each channel 44 allowed minutes 46 and actual minutes 48. Show list 52 records for each show 54 allowed minutes 56, actual minutes 58, and a rating, such as a user or industry provided rating of good/poor, value or the like.

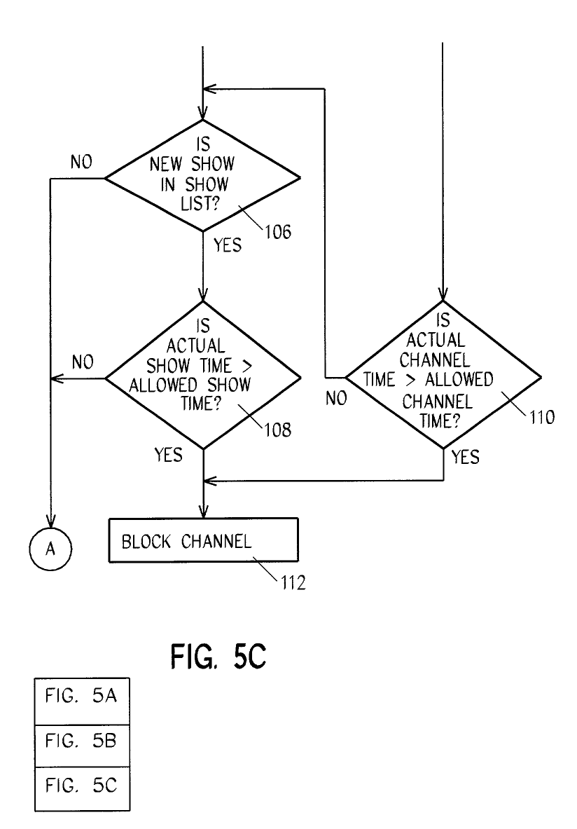

Referring to FIG. 5, a flow chart illustrates the method steps of a preferred embodiment of the invention for managing channel and show usage. In step 60, processing starts as TV system 10 is turned on. In step 62 it is determined if this is the first occurrence of power on today (or whatever period is used for control). If so, in step 64 all actual times 48 and 58 are cleared in lists 42 and 52. In step 66, a global timer (not shown) is started. In step 68, the system detects or obtains a next event, which in this embodiment may be to rate show 54, increment channel 44 up/down (detecting an up arrow or down arrow activation on, for example, a remote channel tuner control), or the selection from a remote numeric key pad of a particular channel 44. If in step 69 the event detected is to rate the show, then in step 67 show list 52 is updated to input the rating 50. If that event 68 is a command to increment the channel 44 up or down, then in step 82 processing proceeds to the next channel 44 in order. If a particular channel 44 selection is detected in step 72, in step 92 normal channel switch to the selected channel 44 is performed. If in step 70 processing flows to next channel 82 via step 82, in step 84 it is determined if skip view processing is turned on. In steps 86 and 88 it is determined responsive to skip view being on if the new show is in show list 52 and, if so, if that show has been previously viewed in this session—which may be detected by that show having actual minutes 58 set to a value greater than zero. Similarly, in steps 86 and 87, if the channel is currently display a show 54 that has a rating 50 of poor (or below some rating value) then in step 90 the display moves to next channel 44. If this show 54 has been viewed previously today, and skip view is on (step 84), then in step 90 next channel (incremented up or down from the channel for this show 54) is selected.

In step 74, responsive to a channel switch event being detected in step 72, it is determined in step 74 if a show guide process is active and, if so, in step 76 all shows already watched are marked and in step 78 displayed. Otherwise, the event obtained in step 68 is something other than channel change, channel switch, or show guide display and that other action is processed in step 80.

In step 94, responsive to selection of a next channel 44 in steps 90 or 92, as the case may be, it is determined if the past channel 44 is in channel list 42. If so, the timer value (started in step 66) is added to the actual minutes 48 for that channel. In step 98 it is determined if the past show is in show list 52 and, if so, the timer value is added to actual minutes 58 for that past show. In step 102, the timer is reset.

In steps 104 and 106, the new channel and new show are tested against channel list 42 and show list 52, respectively. If the new channel is channel list 42, and if in step 110 it is determined that actual channel time 48 is greater than allowed minutes 46, then in step 112 the channel is blocked. The channel is blocked also if in step 108 it is determined that the new show is in list 52 and actual show time 58 exceeds allowed minutes 56. Otherwise, the show is fed to the monitor and processing returns to step 68 to await the next event.

### ADVANTAGES OVER THE PRIOR ART

It is an advantage of the invention that there is provided an improved system and method for operating a channel selection device, such as a set top box.

It is an advantage of the invention that there is provided a system and method for operating a channel selection device to control the channels and programs available for viewing.

It is an advantage of the invention that there is provided a system and method for operating a channel selection device to control the amount of time an individual may view a particular channel or program in a given period.

It is an advantage of the invention that there is provided a system and method for operating a channel selection device during channel surfing to skip blocked channels or shows.

It is an advantage of the invention that there is provided a system and method for operating a channel selection device for reporting the channels and shows viewed by an individual, and the elapsed time of viewing.

It is an advantage of the invention that there is provided a system and method for providing password protection to a channel selection device.

It is an advantage of the invention that there is provided an electronic program guide (EPG) personalized for displaying selected channels and programs.

### ALTERNATIVE EMBODIMENTS

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pseries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. A method for controlling viewing of channels and shows, comprising the steps of:
maintaining in a channel list for each of a plurality of channels allowed channel viewing time and actual channel viewing time;
maintaining in a show list for each of plurality of shows allowed show viewing time and actual show viewing time; and
responsive to selection of a channel by a viewer, accessing said channel list and said show list for selectively inhibiting viewing of the show being presented on said channel.

2. The method of claim 1, further comprising the steps of:
enabling viewing of said show upon determining that said allowed show viewing time exceeds said actual show viewing time.

3. The method of claim 1, further comprising the steps of:
enabling viewing of said channel upon determining that said allowed channel viewing time exceeds said actual channel viewing time.

4. The method of claim 1, further comprising the steps of:
inhibiting viewing of said channel upon determining either that said actual channel viewing time is equal to or greater than said allowed channel viewing time or that said actual show viewing time is equal to or greater than said allowed show viewing time.

5. The method of claim 1, further comprising the steps of:
maintaining in said show list for each of said plurality of shows show rating indicia;
responsive to viewer switching to a next channel, accessing said show rating indicia for the show currently presented on said next channel and responsive to the accessed show rating indicia selectively switching to a further next channel without presenting said show currently presented on said next channel.

6. The method of claim 1, further comprising the step of:
receiving viewer identifying indicia and responsive to said identifying indicia selectively blocking channels or shows.

7. The method of claim 6, further comprising the step of:
blocking access to shows for which said actual show viewing time is non-zero.

8. The method of claim 5, said show rating indicia being a user value selectively indicating those shows which said viewer desires to skip or not skip during channel change events.

9. The method of claim 1, further comprising the step of preparing an output report showing channels and programs viewed and the time spent viewing them.

10. The method of claim 9, further comprising the step of preparing said output report for each of a plurality of viewers.

11. A method for selecting channels for viewing, comprising the steps of:
initializing a channel list including for each of a plurality of channels allowed channel viewing time and actual channel viewing time;
starting a timer;
responsive to a channel switch event, switching channels from a past channel to a new channel; and
responsive to said past channel being included in said channel list, incrementing said actual channel viewing time by the current value of said timer.

12. The method of claim 11, further comprising the step of:
responsive to said channel switch event, blocking said new channel if the actual channel viewing time for said new channel exceeds the allowed channel viewing time for said new channel.

13. The method of claim 12, further comprising the step of:
responsive to a channel guide event, displaying a program guide with shows already watched or rated selectively blocked or highlighted.

14. A method for selecting shows for viewing, comprising the steps of:
initializing a show list including for each of a plurality of shows allowed show viewing time and actual channel viewing time;
starting a timer;
responsive to a channel switch event, switching channels from a past channel to a new channel; and
responsive to the show viewed on said past channel being included in said show list, incrementing said actual show viewing time by the current value of said timer.

15. The method of claim 14, further comprising the step of:
responsive to said channel switch event, blocking said new channel if the actual show viewing time for the new show presented on said new channel exceeds the allowed show viewing time for said new show.

16. The method of claim 15, further comprising the steps of:
responsive to a channel guide event, marking shows already watched or rated; and
displaying a channel guide with marked shows highlighted or blocked.

17. A method for selecting channels and shows for viewing, comprising the steps of:
initializing a channel list including for each of a plurality of channels allowed channel viewing time and actual channel viewing time;
initializing a show list including for each of a plurality of shows allowed show viewing time and actual channel viewing time;
starting a timer;
responsive to a channel switch event, switching channels from a past channel to a new channel;
responsive to said past channel being included in said channel list, incrementing said actual channel viewing time by the current value of said timer; and
responsive to the show viewed on said past channel being included in said show list, incrementing said actual show viewing time by the current value of said timer.

18. The method of claim 17, further comprising the step of:
responsive to said channel switch event, blocking said new channel if the actual show viewing time for the new show presented on said new channel exceeds the allowed show viewing time for said new show or if the actual channel viewing time for said new channel exceeds the allowed channel viewing timer.

19. The method of claim 18, further comprising the step of:
responsive to a channel guide event, displaying a program guide with shows already watched or rated marked or blocked.

20. A method for selecting channels for viewing, comprising the steps of:
initializing a channel list including for each of a plurality of channels allowed channel viewing time and actual channel viewing time;
starting a timer;
responsive to a channel change event, selectively incrementing or decrementing channels from a past channel to a new channel; and
responsive to said past channel being included in said channel list, incrementing said actual channel viewing time by the current value of said timer.

21. The method of claim 20, further comprising the step of:
responsive to said channel change event, blocking said new channel if the actual channel viewing time for said new channel exceeds the allowed channel viewing time for said new channel.

22. The method of claim 20, further comprising the steps of:
maintaining in a show list show rating indicia for each of a plurality of shows;
responsive to said channel change event, selectively incrementing or decrementing past said new channel responsive to the show rating indicia for the show being presented on said new channel.

23. The method of claim 22, further comprising the step of:
responsive to a channel guide event, displaying a channel guide.

24. The method of claim 23, further comprising the step of:
displaying said channel guide with shows already watched or rated highlighted or marked.

25. A method for selecting shows for viewing, comprising the steps of:
initializing a show list including for each of a plurality of shows allowed show viewing time and actual channel viewing time;
starting a timer;
responsive to a channel change event, selectively incrementing or decremeting channels from a past channel to a new channel; and
responsive to the show viewed on said past channel being included in said show list, incrementing said actual show viewing time by the current value of said timer.

26. The method of claim 25, further comprising the step of:
responsive to said channel change event, blocking said new channel if the actual show viewing time for the new show presented on said new channel exceeds the allowed show viewing time for said new show.

27. The method of claim 26, further comprising the steps of:
maintaining in said show list show rating indicia for each of a plurality of shows;
responsive to said channel change event, selectively incrementing or decrementing past said new channel responsive to the show rating indicia for the show being presented on said new channel.

28. The method of claim 25, further comprising the step of:
responsive to a channel guide event, displaying a guide with poorly rated shows blocked and shows already watched marked.

29. A method for selecting channels and shows for viewing, comprising the steps of:
initializing a channel list including for each of a plurality of channels allowed channel viewing time and actual channel viewing time;
initializing a show list including for each of a plurality of shows allowed show viewing time and actual channel viewing time;
starting a timer;
responsive to a channel change event, selectively incrementing or decrementing channels from a past channel to a new channel;
responsive to said past channel being included in said channel list, incrementing said actual channel viewing time by the current value of said timer; and
responsive to the show viewed on said past channel being included in said show list, incrementing said actual show viewing time by the current value of said timer.

30. The method of claim 29, further comprising the step of:
responsive to said channel change event, blocking said new channel if the actual show viewing time for the new show presented on said new channel exceeds the allowed show viewing time for said new show or if the actual channel viewing time for said new channel exceeds the allowed channel viewing timer.

31. The method of claim 29, further comprising the steps of:
maintaining in said show list show rating indicia for each of a plurality of shows;
responsive to said channel change event, selectively incrementing or decrementing past said new channel responsive to the show rating indicia for the show being presented on said new channel.

32. The method of claim 31, further comprising the step of:
responsive to a channel guide event, displaying a guide with poorly rated shows blocked and shows already watched marked.

33. The method of claim 32, further comprising the step of:
receiving viewer identifying indicia and responsive to said identifying indicia selectively blocking channels or shows.

34. System for controlling viewing of channels and shows, comprising:
a television display;
programmable apparatus for selecting television channels for viewing and including a channel list and a show list;
said channel list for maintaining for each of a plurality of channels allowed channel viewing time and actual channel viewing time;
said show list for maintaining for each of plurality of shows allowed show viewing time and actual show viewing time; and
programmable controls responsive to selection of a channel by a viewer for accessing said channel list and said show list for selectively inhibiting viewing of a show being presented on said channel.

35. A set top box system for controlling viewing of channels and shows, comprising:
a television display;
a timer;
a channel list;
a show list;
programmable apparatus for selecting television channels for viewing and including a channel list and a show list;
said programmable apparatus being operable for initializing said channel list to include for each of a plurality of channels allowed channel viewing time;
said programmable apparatus being operable for initializing said show list to include for each of a plurality of shows allowed show viewing time;
said programmable apparatus being operable responsive to a channel change event for selectively incrementing or decrementing channels from a past channel to a new channel;
said programmable apparatus being operable responsive to said past channel being included in said channel list for incrementing said actual channel viewing time by the current value of said timer; and
said programmable apparatus being operable responsive to the show viewed on said past channel being included in said show list for incrementing said actual show viewing time by the current value of said timer.

36. A program storage device readable by a machine, tangibly embodying a program of instructions executable by a machine to perform method steps for controlling viewing of channels and shows, said method steps comprising:
maintaining in a channel list for each of a plurality of channels allowed channel viewing time and actual channel viewing time;
maintaining in a show list for each of plurality of shows allowed show viewing time and actual show viewing time; and
responsive to selection of a channel by a viewer, accessing said channel list and said show list for selectively inhibiting viewing of the show being presented on said channel.

37. A computer program product or computer program element for controlling viewing of channels and shows according to method steps comprising:
maintaining in a channel list for each of a plurality of channels allowed channel viewing time and actual channel viewing time;
maintaining in a show list for each of plurality of shows allowed show viewing time and actual show viewing time; and
responsive to selection of a channel by a viewer, accessing said channel list and said show list for selectively inhibiting viewing of the show being presented on said channel.

38. A program storage device readable by a machine, tangibly embodying a program of instructions executable by a machine to perform method steps for selecting channels for viewing, said method steps comprising:
initializing a channel list including for each of a plurality of channels allowed channel viewing time and actual channel viewing time;
starting a timer;
responsive to a channel switch event, switching channels from a past channel to a new channel; and
responsive to said past channel being included in said channel list, incrementing said actual channel viewing time by the current value of said timer.

39. A program storage device readable by a machine, tangibly embodying a program of instructions executable by a machine to perform method steps for selecting shows for viewing, said method steps comprising:
initializing a show list including for each of a plurality of shows allowed show viewing time and actual channel viewing time;
starting a timer;
responsive to a channel switch event, switching channels from a past channel to a new channel; and
responsive to the show viewed on said past channel being included in said show list, incrementing said actual show viewing time by the current value of said timer.

40. A program storage device readable by a machine, tangibly embodying a program of instructions executable by a machine to perform method steps for selecting channels and shows for viewing, said method steps comprising:
initializing a channel list including for each of a plurality of channels allowed channel viewing time and actual channel viewing time;
initializing a show list including for each of a plurality of shows allowed show viewing time and actual channel viewing time;
starting a timer;
responsive to a channel switch event, switching channels from a past channel to a new channel;
responsive to said past channel being included in said channel list, incrementing said actual channel viewing time by the current value of said timer; and
responsive to the show viewed on said past channel being included in said show list, incrementing said actual show viewing time by the current value of said timer.

41. A program storage device readable by a machine, tangibly embodying a program of instructions executable by a machine to perform method steps for selecting channels and shows for viewing, said method steps comprising:
initializing a channel list including for each of a plurality of channels allowed channel viewing time and actual channel viewing time;
initializing a show list including for each of a plurality of shows allowed show viewing time and actual channel viewing time;
starting a timer;
responsive to a channel change event, selectively incrementing or decrementing channels from a past channel to a new channel;
responsive to said past channel being included in said channel list, incrementing said actual channel viewing time by the current value of said timer; and
responsive to the show viewed on said past channel being included in said show list, incrementing said actual show viewing time by the current value of said timer.
